(19) United States
(12) Patent Application Publication
(10) Pub. No.: US 2026/0015003 A1
(43) Pub. Date: Jan. 15, 2026

(54) ASSISTANCE FUNCTION PRESENTATION DEVICE

(71) Applicant: TOYOTA JIDOSHA KABUSHIKI KAISHA, Toyota-shi (JP)

(72) Inventors: Masahiro HIRAKO, Tokyo (JP); Yudai SADAKUNI, Tokyo (JP); Arata TAKADA, Toyota-shi (JP)

(73) Assignee: TOYOTA JIDOSHA KABUSHIKI KAISHA, Toyota-shi (JP)

(21) Appl. No.: 19/223,415

(22) Filed: May 30, 2025

(30) Foreign Application Priority Data
Jul. 12, 2024 (JP) 2024-112636

(51) Int. Cl. B60W 50/14; G06V 20/58

(52) U.S. Cl. CPC B60W 50/14; G06V 20/582; B60W 2050/143; B60W 2050/146; B60W 2420/403; B60W 2520/10; B60W 2554/4042; B60W 2556/10

(57) ABSTRACT

An assistance function presentation device presents an operation method for a driving assistance function of a host vehicle. The assistance function presentation device includes: an information acquisition unit configured to acquire surrounding environment information of the host vehicle; a situation determination unit configured to determine whether or not a driver of the host vehicle is in a high-load situation in which a load on driving operations is high; and a presentation control unit configured to present the operation method to the driver when the driving assistance function is available or in operation and it is determined by the situation determination unit that a current situation is not the high-load situation.

### CROSS-REFERENCE TO RELATED APPLICATIONS

This application is based upon and claims the benefit of priority from Japanese Patent Application No. 2024-112636, filed on Jul. 12, 2024, the entire contents of which are incorporated herein by reference.

### TECHNICAL FIELD

The present disclosure relates to an assistance function presentation device that presents an operation method for a driving assistance function of a vehicle.

### BACKGROUND

For example, Japanese Unexamined Patent Publication No. 2023-93162 discloses a device that notifies a vehicle user that a driving assistance function can be executed. This device determines whether or not the conditions for activating the driving assistance function are satisfied based on vehicle driving data. Then, when the activation conditions are satisfied, the device provides notification to the vehicle user.

### SUMMARY

Here, there may be a case where the vehicle user does not know how to operate the driving assistance function even if the driving assistance function is executable. For this reason, it may be considered to present an operation method for the driving assistance function, but it may not be appropriate to present the operation method uniformly.

Therefore, in the present disclosure, an assistance function presentation device capable of presenting an operation method for a driving assistance function at an appropriate timing will be described.

An assistance function presentation device according to one aspect of the present disclosure is [1] “an assistance function presentation device for presenting an operation method for a driving assistance function of a vehicle, including: an information acquisition unit configured to acquire surrounding environment information of the vehicle; a situation determination unit configured to determine whether or not a driver of the vehicle is in a high-load situation in which a load on driving operations is high; and a presentation control unit configured to present the operation method to the driver when the driving assistance function is available or in operation and it is determined by the situation determination unit that a current situation is not the high-load situation”.

This assistance function presentation device presents an operation method for the driving assistance function to the driver based not only on whether or not the driving assistance function is available or in operation but also on whether or not the driver is in a high-load situation in which a load on driving operations is high. Here, when the driver is in a high-load situation in which a load on driving operations is high, the driver needs to concentrate on the driving operations. In such a case, if an operation method for the driving assistance function is presented, the driver's attention to driving operations may be diverted. For this reason, the assistance function presentation device presents an operation method to the driver when the driving assistance function is available and it is determined that the current situation is not a high-load situation. In this manner, the assistance function presentation device can present an operation method for the driving assistance function at an appropriate timing. Then, the driver can easily operate the driving assistance function based on the presented operation method.

The assistance function presentation device according to one aspect of the present disclosure may be [2] “the assistance function presentation device according to [1] above, wherein the surrounding environment information includes information on other vehicles around the vehicle, the driving assistance function is a vehicle speed maintenance function for driving the vehicle at a set speed set in advance, and when the vehicle speed maintenance function is in operation, it is determined by the situation determination unit that the current situation is not the high-load situation, and a difference between a speed of the vehicle and a speed of each of the other vehicles obtained from the surrounding environment information is equal to or greater than a predetermined speed threshold value, the presentation control unit presents a method for changing the set speed of the vehicle speed maintenance function as the operation method”.

For example, when the speed of the vehicle differs from the speed of other surrounding vehicles, it is considered that the vehicle cannot travel along the flow of the other surrounding vehicles. That is, it may be preferable to change the set speed of the vehicle speed maintenance function so as to follow the flow of the other surrounding vehicles. For this reason, when the difference between the speed of the vehicle and the speed of other surrounding vehicles is equal to or greater than a predetermined threshold value, the assistance function presentation device presents a method for changing the set speed of the vehicle speed maintenance function. In this manner, the assistance function presentation device can present a method for changing the set speed as an operation method for the vehicle speed maintenance function at a more appropriate timing. Then, the driver can easily perform an operation to change the set speed of the vehicle speed maintenance function based on the presented operation method.

The assistance function presentation device according to one aspect of the present disclosure may be [3] “the assistance function presentation device according to [1] above, wherein the surrounding environment information includes a recognition result of a road sign indicating a speed limit of a road on which the vehicle is traveling, the driving assistance function is a vehicle speed maintenance function for driving the vehicle at a set speed set in advance, and when the vehicle speed maintenance function is in operation, it is determined by the situation determination unit that the current situation is not the high-load situation, and a difference between a speed of the vehicle and the speed limit indicated by the road sign obtained from the surrounding environment information is equal to or greater than a predetermined speed threshold value, the presentation control unit presents a method for changing the set speed of the vehicle speed maintenance function as the operation method”.

For example, when the speed of the vehicle differs from the speed limit indicated by the road sign, it is considered that the vehicle cannot travel in accordance with the speed limit. That is, it may be preferable to change the set speed of the vehicle speed maintenance function so as to conform to the speed limit. For this reason, when the difference between the speed of the vehicle and the speed limit indicated by the road sign is equal to or greater than a predetermined threshold value, the assistance function presentation device presents a method for changing the set speed of the vehicle speed maintenance function. In this manner, the assistance function presentation device can present a method for changing the set speed as an operation method for the vehicle speed maintenance function at a more appropriate timing. Then, the driver can easily perform an operation to change the set speed of the vehicle speed maintenance function based on the presented operation method.

The assistance function presentation device according to one aspect of the present disclosure may be [4] “the assistance function presentation device according to [1] above, wherein the information acquisition unit further acquires information on a driving route along which the vehicle travels, the driving assistance function is a vehicle speed maintenance function for driving the vehicle at a set speed set in advance, and when the vehicle is traveling on a highway, the presentation control unit calculates a distance to an exit where the vehicle is to exit the highway based on the driving route information, and presents a method for canceling the vehicle speed maintenance function as the operation method when the vehicle speed maintenance function is in operation, it is determined by the situation determination unit that the current situation is not the high-load situation, the vehicle is traveling on a highway, and the calculated distance to the exit is equal to or less than a predetermined distance threshold value”.

For example, in places other than highways, it may not be suitable or possible to use the vehicle speed maintenance function for driving the vehicle at a set speed. For this reason, it is preferable for the driver to deactivate the vehicle speed maintenance function before exiting the highway. Therefore, when the distance to the exit of the highway is equal to or less than a predetermined distance threshold value while the vehicle speed maintenance function is in operation, the assistance function presentation device presents a method for canceling the vehicle speed maintenance function. In this manner, the assistance function presentation device can present a method for canceling the vehicle speed maintenance function as an operation method for the vehicle speed maintenance function at a more appropriate timing. Then, the driver can easily perform an operation to cancel the vehicle speed maintenance function based on the presented operation method.

The assistance function presentation device according to one aspect of the present disclosure may be [5] “the assistance function presentation device according to any one of [1] to [4] above, wherein the information acquisition unit further acquires usage history information of the driver of the vehicle regarding the driving assistance function, and the presentation control unit determines, based on the usage history information, whether or not the number of times the driving assistance function has been used by the driver is equal to or greater than a predetermined threshold value for the number of times, and does not present the operation method to the driver when the number of times the driving assistance function has been used is equal to or greater than the predetermined threshold value for the number of times”.

When the driving assistance function is used frequently, it is considered that the driver knows or understands the operation method for the driving assistance function. On the other hand, when the driving assistance function is used infrequently, it is considered that the driver does not know or understand the operation method for the driving assistance function. For this reason, when the number of times the driving assistance function has been used by the driver is equal to or greater than a predetermined threshold value for the number of times, the assistance function presentation device does not present the operation method. On the other hand, when the number of times the driving assistance function has been used by the driver is less than the predetermined threshold value for the number of times, the assistance function presentation device presents the operation method. In this manner, the assistance function presentation device can more appropriately present the operation method for the driving assistance function based on the number of times the driving assistance function has been used. In addition, the assistance function presentation device does not present the operation method to a driver who knows or understands the operation method for the driving assistance function. Therefore, the assistance function presentation device can prevent the driver from feeling uncomfortable due to the presentation of the operation method for the driving assistance function.

The assistance function presentation device according to one aspect of the present disclosure may be [6] “the assistance function presentation device according to any one of [1] to [4] above, wherein the information acquisition unit further acquires information on a level of the vehicle driver's understanding on the driving assistance function, and the presentation control unit determines, based on the understanding level information, whether or not the level of understanding on the driving assistance function is equal to or greater than a predetermined understanding level threshold value, and does not present the operation method to the driver when the level of understanding is equal to or greater than the predetermined understanding level threshold value”.

When the level of understanding on the driving assistance function is high, it is considered that the driver understands the operation method for the driving assistance function. On the other hand, when the level of understanding on the driving assistance function is low, it is considered that the driver does not understand the operation method for the driving assistance function. For this reason, when the level of the driver's understanding on the driving assistance function is equal to or higher than a predetermined understanding level threshold value, the assistance function presentation device does not present the operation method. On the other hand, when the level of the driver's understanding on the driving assistance function is less than the predetermined understanding level threshold value, the assistance function presentation device presents the operation method. In this manner, the assistance function presentation device can more appropriately present the operation method for the driving assistance function based on the level of understanding on the driving assistance function. In addition, the assistance function presentation device does not present the operation method to a driver who understands the operation method for the driving assistance function. Therefore, the assistance function presentation device can prevent the driver from feeling uncomfortable due to the presentation of the operation method for the driving assistance function.

According to one aspect of the present disclosure, it is possible to present an operation method for the driving assistance function at an appropriate timing.

### BRIEF DESCRIPTION OF THE DRAWINGS

FIG. 1 is a block diagram showing an example of an assistance function presentation device according to an embodiment.

FIG. 2 is an example of a display screen of a display when presenting an operation method for starting the execution of an inter-vehicle distance control function.

FIG. 3 is an example of a display screen of a display when presenting an operation method for changing the settings of the inter-vehicle distance control function.

FIG. 4 is a flowchart showing the flow of an operation method presentation process performed in the assistance function presentation device.

### DETAILED DESCRIPTION

Hereinafter, exemplary embodiments will be described with reference to the drawings. In addition, in each drawing, the same or equivalent elements are denoted by the same reference numerals, and repeated description thereof will be omitted.

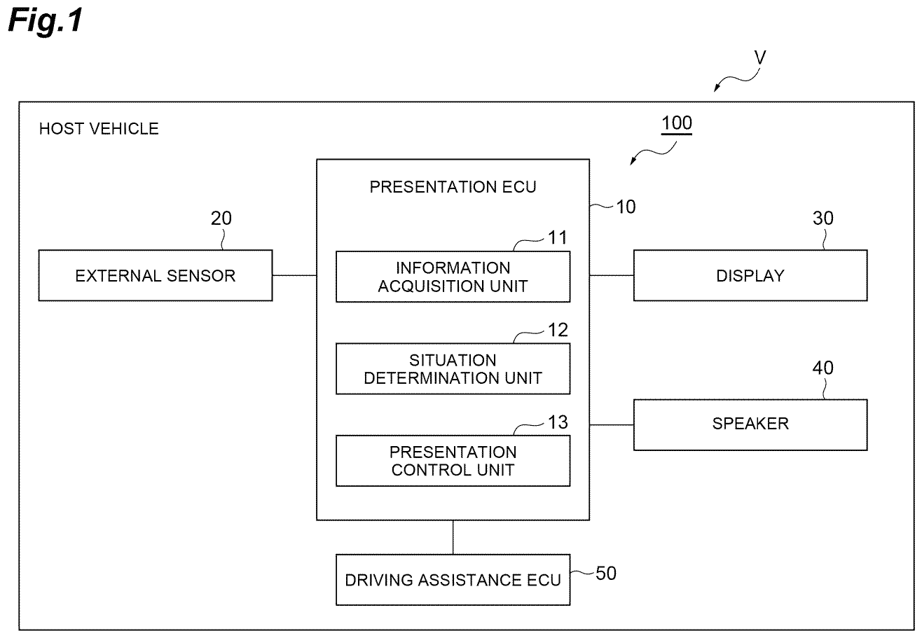

As shown in FIG. 1, an assistance function presentation device 100 is mounted in a host vehicle V (vehicle). The host vehicle V can be driven manually by a driver performing driving operations. In addition to manual driving, the host vehicle V can execute a driving assistance function for assisting the driver in driving the host vehicle V. The assistance function presentation device 100 presents an operation method for the driving assistance function of the host vehicle V to the driver (passenger) of the host vehicle V. Therefore, the driver can perform operations, such as starting the use of the driving assistance function, changing settings, and ending the use, based on the presented operation method.

The assistance function presentation device 100 includes a presentation ECU (electronic control unit) 10 for overall management of the device. The presentation ECU 10 is an electronic control unit having a central processing unit (CPU) and a storage unit. Examples of the storage unit include a read only memory (ROM), a random access memory (RAM), and an electrically erasable programmable read-only memory (EEPROM). In the presentation ECU 10, for example, the CPU executes programs stored in the storage unit to realize various functions. The presentation ECU 10 may be configured by a plurality of electronic control units.

An external sensor 20, a display 30, a speaker 40, and a driving assistance ECU 50 are connected to the presentation ECU 10. These devices connected to the presentation ECU 10 are mounted in the host vehicle V.

The external sensor 20 is a detection device that detects the surrounding conditions of the host vehicle V. The surrounding conditions include other vehicles, pedestrians, obstacles, dividing lines on the road, road signs, and the status of traffic lights around the host vehicle V. The external sensor 20 includes at least one of a camera and a radar sensor. The camera is an imaging apparatus for imaging the external conditions of the host vehicle V. The camera is provided, for example, on the back side of the windshield of the host vehicle V to image the front of the host vehicle V. The camera transmits a captured image regarding the external conditions of the host vehicle V to the presentation ECU 10. The radar sensor is a detection device that detects an object around the host vehicle V using radio waves (for example, millimeter waves) or light. Examples of the radar sensor include a millimeter wave radar and a LiDAR (light detection and ranging). The radar sensor transmits information on the detected object to the presentation ECU 10.

The display 30 is a display device that visually presents information to the driver of the host vehicle V. The display 30 is provided in the passenger compartment of the host vehicle V. The display 30 may be a center display, a multi information display (MID), or a head up display (HUD). The display 30 displays various kinds of information in response to a control signal from the presentation ECU 10.

The speaker 40 is a device that presents information to the driver of the host vehicle V by sound. The speaker 40 outputs sound or the like in response to a control signal from the presentation ECU 10.

The driving assistance ECU 50 is an electronic control unit configured by the same devices as the presentation ECU 10. The driving assistance ECU 50 can execute a driving assistance function for assisting the driver in driving the host vehicle V. The driving assistance ECU 50 executes a driving assistance function using the detection results of the external sensor 20 and the like.

The driving assistance ECU 50 can execute a driving assistance function by controlling the behavior of the host vehicle V. In this case, the driving assistance ECU 50 controls the behavior of the host vehicle V by outputting a control signal to an actuator mounted in the host vehicle V. This actuator includes, for example, at least one of a steering actuator that controls the steering of the host vehicle V, a power actuator that controls the speed of the host vehicle V, and a brake actuator that controls the brakes of the host vehicle V. The power actuator controls the output of a power source (such as an engine or a motor) of the host vehicle V.

The driving assistance ECU 50 can execute, as driving assistance functions, various functions for assisting the driver's driving operations, such as a vehicle speed maintenance function, an inter-vehicle distance control function, and a lane keeping assistance function. The vehicle speed maintenance function is, for example, a function for driving the host vehicle V at a set vehicle speed that is set in advance. This set vehicle speed can be set, for example, by the driver. The vehicle speed maintenance function may be executed, for example, on the highway. The inter-vehicle distance control function is, for example, a function for driving the host vehicle V while maintaining a constant inter-vehicle distance from other vehicles ahead. The inter-vehicle distance control function may be executed, for example, on the highway. The lane keeping assistance function is, for example, a function of controlling the steering of the host vehicle V so that the host vehicle V does not deviate from the driving lane.

When the driving assistance function becomes available, the driving assistance ECU 50 starts executing the driving assistance function based on an instruction from the driver. The driving assistance function becomes available when the execution conditions for the driving assistance ECU 50 to execute the driving assistance function are satisfied. The execution conditions are set in advance for each driving assistance function based on, for example, the vehicle speed of the host vehicle V, the conditions around the host vehicle V, and the type of road on which the host vehicle V is traveling (general road or highway). In addition, when the driving assistance function is in operation (being executed), the driving assistance ECU 50 can end the execution of the driving assistance function based on an instruction from the driver.

Next, the functional configuration of the presentation ECU 10 will be described. The presentation ECU 10 functionally includes an information acquisition unit 11, a situation determination unit 12, and a presentation control unit 13.

The information acquisition unit 11 acquires surrounding environment information, which is information on the surroundings of the host vehicle V. The surrounding environment information includes, for example, the positions of other vehicles (or pedestrians, obstacles, and the like) with respect to the host vehicle V, the positions and shapes of dividing lines on the road, information on road signs on the road (road sign recognition results), and the status of traffic lights. In addition, for example, the information acquisition unit 11 may recognize the surrounding environment based on the detection result of the external sensor 20 and acquire the recognized information as surrounding environment information. For example, the information acquisition unit 11 may recognize the positions and shapes of dividing lines, road signs, and the contents of the road signs from an image captured by a camera serving as the external sensor 20, based on a known image processing technique.

In addition, the information acquisition unit 11 may acquire information on the positions and shapes of dividing lines, road signs, and the like, based on map information. The information acquisition unit 11 may acquire surrounding environment information based on a plurality of information sources, such as the external sensor 20 and map information.

The information acquisition unit 11 can further acquire information on the driving route along which the host vehicle V travels. The driving route information includes the route along which the host vehicle V travels, the type of road along which the host vehicle V travels (such as a general road or a highway), and the location information of the entrances and exits of a highway when the host vehicle V is traveling on the highway. The information acquisition unit 11 can acquire the driving route information, for example, from a navigation system that guides the host vehicle V to a set destination.

The information acquisition unit 11 can further acquire usage history information of the driver of the host vehicle V regarding the driving assistance function. The usage history information of the driving assistance function includes, for each driving assistance function, the number of times that the driving assistance function has been used. In addition, the usage history information of the driving assistance function may include, for each driving assistance function, the date and time when the driving assistance function was used. The information acquisition unit 11 can acquire the usage history information from the driving assistance ECU 50, for example.

The information acquisition unit 11 can further acquire understanding level information of the driver of the host vehicle V regarding the driving assistance function. The understanding level information regarding the driving assistance function includes the level of understanding on the driving assistance function. The level of understanding on the driving assistance function refers to the level of understanding on the assistance content (behavior of the host vehicle V controlled by the assistance) of the driving assistance function and the operation method. The level of understanding is determined for each of a plurality of driving assistance functions.

For example, a test may be performed in advance to check the level of the driver's understanding on the driving assistance function. The understanding level information may be determined based on the result of the test. For example, the assistance function presentation device 100 may perform a test using the display 30 or the like and acquire the understanding level information based on the result of the test. Without being limited thereto, the test may be performed by a tester or the like, and the result may be input to the assistance function presentation device 100 as understanding level information. In this manner, the information acquisition unit 11 can acquire the understanding level information regarding the driving assistance function that is set by various methods.

The situation determination unit 12 determines, based on the surrounding environment information acquired by the information acquisition unit 11, whether or not the driver of the host vehicle V is in a high-load situation in which a load on driving operations is high. The criteria for determining whether or not the current situation is a high-load situation is set in advance. The high-load situation may be, for example, a situation in which there are many other vehicles around the host vehicle V and there are many points to check around the host vehicle V or a situation in which the host vehicle V is about to enter a sharp curve or is traveling around a sharp curve.

Specifically, for example, when the number of other vehicles present within a predetermined range around the host vehicle V is equal to or greater than a predetermined threshold value for the number of vehicles, the situation determination unit 12 may determine that the current situation is a high-load situation. For example, when the curvature of a curved road on which the host vehicle V is about to enter or is traveling is equal to or greater than a predetermined curvature threshold value (when the curve is sharp), the situation determination unit 12 may determine that the current situation is a high-load situation. Thus, the high-load situation is determined based on at least a situation outside the host vehicle V.

In addition, the situation determination unit 12 may determine whether or not the current situation is a high-load situation in consideration of the vehicle speed of the host vehicle V. In this case, when the vehicle speed of the host vehicle V is high, the situation determination unit 12 lowers the criteria for determining the high-load situation compared to when the vehicle speed is low. That is, the situation determination unit 12 is likely to determine that the current situation is a high-load situation when the vehicle speed of the host vehicle V is high, compared to when the vehicle speed is low.

For example, when the vehicle speed is high, the surrounding conditions change quickly. This requires the driver to check the surroundings more carefully or to drive more carefully, which tends to increase the load on the driver's driving operations. For this reason, the situation determination unit 12 is likely to determine that the current situation is a high-load situation when the vehicle speed is high.

In addition, when making a determination based on the number of other vehicles around the host vehicle V as described above, it is possible to make it easier to determine that the current situation is a high-load situation by setting the threshold value for the number of vehicles to a small value. When making a determination based on the curvature of the curved road as described above, it is possible to make it easier to determine that the current situation is a high-load situation by setting the curvature threshold value to a small value.

The presentation control unit 13 presents an operation method for the driving assistance function to the driver of the host vehicle V. The presentation control unit 13 can present the operation method using at least one of display on the display 30, sound output from the speaker 40, and the like. Presenting the operation method by the presentation control unit 13 includes presenting the installation positions of operation switches (touch positions of a touch panel and the like are also included) to be operated when operating the driving assistance function. Presenting the operation method by the presentation control unit 13 may include presenting what kind of control is performed by operating which switch.

The presentation control unit 13 presents an operation method when the driving assistance function is available or in operation and it is determined by the situation determination unit 12 that the current situation is not a high-load situation. The presentation control unit 13 does not present the operation method when the driving assistance function is not available. In addition, even if the driving assistance function is available or in operation, when it is determined by the situation determination unit 12 that the current situation is a high-load situation, the presentation control unit 13 does not present the operation method. In addition, the presentation control unit 13 can acquire, for example, information on whether or not the driving assistance function is available or in operation from the driving assistance ECU 50.

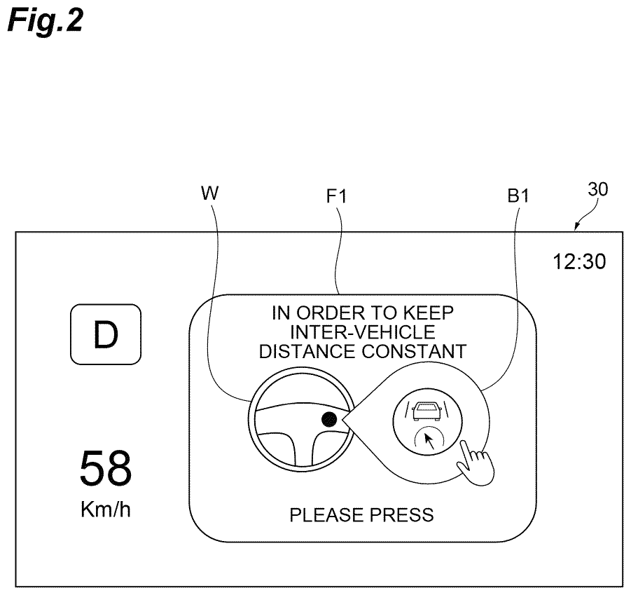

For example, it is assumed that the inter-vehicle distance control function is available as a driving assistance function and the situation determination unit 12 determines that the current situation is not a high-load situation. In this case, the presentation control unit 13 can display on the display 30 an operation method for starting the execution of the inter-vehicle distance control function. Specifically, the presentation control unit 13 displays an operation method display F1 on the display 30 as shown in FIG. 2, for example. The operation method display F1 shows the installation position of an execution start switch B1 for starting the execution of the inter-vehicle distance control function. Here, a figure shows that the execution start switch BI is provided on the right side of the center of a steering wheel W.

Therefore, the driver of the host vehicle V can recognize the installation position of the execution start switch B1 for the inter-vehicle distance control function and operate the execution start switch B1. When the driver actually operates the execution start switch B1 provided on the steering wheel W, the display screen of the display 30 may also change in response to the driver's operation. For example, a display indicating that the execution start switch B1 has been operated may be given, or the color of the execution start switch B1 on the display 30 may be changed.

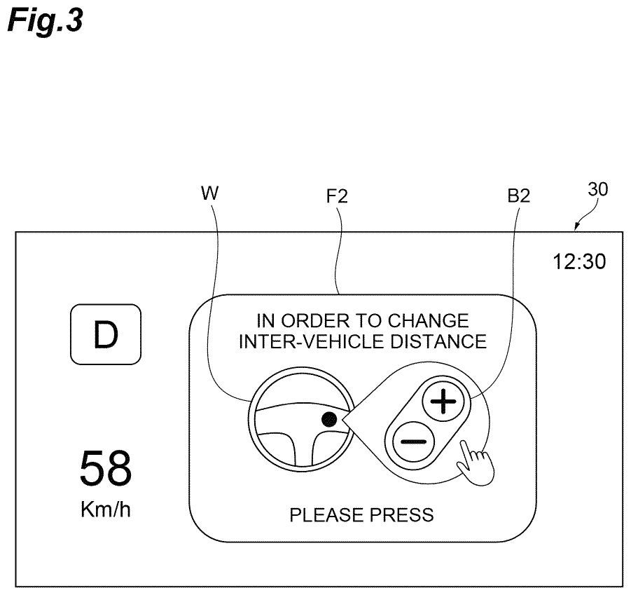

For example, it is assumed that the inter-vehicle distance control function is in operation as a driving assistance function and it is determined by the situation determination unit 12 that the current situation is not a high-load situation. In this case, the presentation control unit 13 can display, on the display 30, a method for changing the settings of the inter-vehicle distance control function as an operation method for the inter-vehicle distance control function. Here, changing the settings of the inter-vehicle distance control function means changing the preset inter-vehicle distance between the host vehicle V and other vehicles ahead. Specifically, the presentation control unit 13 displays an operation method display F2 on the display 30 as shown in FIG. 3, for example. The operation method display F2 shows the installation position of a setting change switch B2 for changing the set inter-vehicle distance of the inter-vehicle distance control function. Here, a figure shows that the setting change switch B2 is provided on the right side of the center of the steering wheel W.

Therefore, the driver of the host vehicle V can recognize the installation position of the setting change switch B2 for the inter-vehicle distance control function and operate the setting change switch B2. When the driver actually operates the setting change switch B2 provided on the steering wheel W, the display screen of the display 30 may also change in response to the driver's operation. For example, a display indicating that the setting change switch B2 has been operated may be given, or the color of the setting change switch B2 on the display 30 may be changed.

### First Specific Example

Hereinafter, still another specific example in which the presentation control unit 13 presents an operation method for the driving assistance function will be described. First, a first specific example will be described. In the first specific example, the surrounding environment information acquired by the information acquisition unit 11 includes information on other vehicles around the host vehicle V. The information on other vehicles includes information on the positions of the other vehicles with respect to the host vehicle V. The information on other vehicles may include information on the speed of the other vehicles, in addition to the information on the positions of the other vehicles with respect to the host vehicle V. In addition, it is assumed that the driving assistance ECU 50 can execute, as a driving assistance function, a vehicle speed maintenance function for driving the host vehicle V at a set speed that is set in advance.

The presentation control unit 13 determines whether or not the vehicle speed maintenance function is in operation, whether or not it is determined by the situation determination unit 12 that the current situation is not a high-load situation, and whether or not a difference between the speed of the host vehicle V and the speed of each of other vehicles obtained from the surrounding environment information is equal to or greater than a predetermined speed threshold value. When these determination conditions are satisfied, the presentation control unit 13 presents, as an operation method, a method for changing the set speed of the vehicle speed maintenance function.

In addition, the presentation control unit 13 can calculate the speed of the surrounding vehicles based on changes in the positions of the other vehicles included in the surrounding environment information. Alternatively, when the speed of other vehicles is included in the surrounding environment information, the presentation control unit 13 can use the speed as the speed of other vehicles. In addition, the other vehicles herein refer to vehicles around the host vehicle V that are traveling in the same direction as the host vehicle V. The other vehicles herein refer to other vehicles around the host vehicle V that are traveling within a predetermined distance from the host vehicle V. When there are a plurality of other vehicles, the presentation control unit 13 may use the average value of the speeds of the plurality of other vehicles as the speed of the other vehicles or may use the speed of the other vehicle traveling at a position closest to the host vehicle V, for example.

That is, determining whether or not the difference between the speed of the host vehicle V and the speed of each of other vehicles is equal to or greater than a predetermined speed threshold value means determining whether or not the host vehicle V can travel along the flow of other surrounding vehicles. Thus, when the current situation is not a high-load situation and the host vehicle V cannot travel along the flow of other surrounding vehicles, the presentation control unit 13 presents a method for changing the set speed of the vehicle speed maintenance function. For example, when the speed of the host vehicle V is higher than the speed of other vehicles, the presentation control unit 13 may present a method for reducing the set speed of the vehicle speed maintenance function. For example, when the speed of the host vehicle V is lower than the speed of other vehicles, the presentation control unit 13 may present a method for increasing the set speed of the vehicle speed maintenance function.

### Second Specific Example

Next, a second specific example will be described. In the second specific example, the surrounding environment information acquired by the information acquisition unit 11 includes the recognition result (speed limit indicated by the road sign) of a road sign indicating the speed limit of the road on which the host vehicle V is traveling. In addition, the driving assistance ECU 50 can execute, as a driving assistance function, a vehicle speed maintenance function for driving the host vehicle V at a set speed that is set in advance.

The presentation control unit 13 determines whether or not the vehicle speed maintenance function is in operation, whether or not it is determined by the situation determination unit 12 that the current situation is not a high-load situation, and whether or not a difference between the speed of the host vehicle V and the speed limit indicated by the road sign obtained from the surrounding environment information is equal to or greater than a predetermined speed threshold value. When these determination conditions are satisfied, the presentation control unit 13 presents, as an operation method, a method for changing the set speed of the vehicle speed maintenance function. In addition, the presentation control unit 13 can acquire the vehicle speed of the host vehicle V based on the detection result of a vehicle speed sensor (not shown). For example, when the speed of the host vehicle V is higher than the speed limit indicated by the road sign, the presentation control unit 13 presents a method for reducing the set speed of the vehicle speed maintenance function.

### Third Specific Example

Next, a third specific example will be described. In the third specific example, the information acquisition unit 11 acquires driving route information in addition to the surrounding environment information. In addition, the driving assistance ECU 50 can execute, as a driving assistance function, a vehicle speed maintenance function for driving the host vehicle V at a set speed that is set in advance. In addition, in the third specific example, when the host vehicle V is traveling on the highway, the presentation control unit 13 calculates a distance to the exit where the host vehicle V is to exit the highway based on the driving route information acquired by the information acquisition unit 11.

The presentation control unit 13 determines whether or not the vehicle speed maintenance function is in operation, whether or not it is determined by the situation determination unit 12 that the current situation is not a high-load situation, whether or not the host vehicle Vis traveling on the highway, and whether or not the calculated distance to the exit of the highway is equal to or less than a predetermined distance threshold value. When these determination conditions are satisfied, the presentation control unit 13 presents, as an operation method, a method for canceling the vehicle speed maintenance function.

In addition, when presenting an operation method in the various examples described above, the presentation control unit 13 can further determine whether or not it is necessary to present the operation method based on the usage history of the driver of the host vehicle V regarding the driving assistance function. For example, when the driving assistance function is used frequently, it is considered that the driver knows or understands the operation method for the driving assistance function. For this reason, when the driving assistance function is used frequently, the presentation control unit 13 does not present the operation method even if it is determined in the various examples described above that the operation method for the driving assistance function should be presented. The presentation control unit 13 determines whether or not it is necessary to present an operation method for each of a plurality of driving assistance functions based on the number of times each driving assistance function has been used.

Specifically, the information acquisition unit 11 acquires usage history information of the driver of the host vehicle V regarding the driving assistance function. As described above, the usage history information includes the number of times each driving assistance function has been used. The presentation control unit 13 determines, based on the usage history information acquired by the information acquisition unit 11, whether or not the number of times the driver has used the driving assistance function is equal to or greater than a predetermined threshold value for the number of times. When the number of times the driving assistance function has been used is equal to or greater than the predetermined threshold value for the number of times, the presentation control unit 13 does not present the operation method to the driver even if it is determined in the various examples described above that the operation method for the driving assistance function should be presented.

In addition, the presentation control unit 13 may use, as the number of times the driving assistance function has been used that is to be compared with the threshold value for the number of times, the number of uses in the entire period from the past to the present or the number of uses in a predetermined period from the present to the past.

The usage history information acquired by the information acquisition unit 11 may be determined for each driver. In this case, for example, the driving assistance ECU 50 may identify the driver who drives the host vehicle V and collect usage history information for each driver. For example, the driving assistance ECU 50 may identify the driver based on a face image captured by a driver monitor camera or the like, or when the driver inputs information to identify himself or herself to the host vehicle V, may identify the driver based on the information. The information acquisition unit 11 acquires usage history information collected by the driving assistance ECU 50 for each driver. Then, using the usage history information corresponding to the driver driving the host vehicle V, the presentation control unit 13 may determine whether or not it is necessary to present the operation method based on the number of times the driver has used the driving assistance function. In addition, similar to the driving assistance ECU 50, the presentation control unit 13 may identify the driver based on a face image captured by a driver monitor camera or the like, or when the driver inputs information to identify himself or herself to the host vehicle V, may identify the driver based on the information. The method by which the presentation control unit 13 identifies the driver is not particularly limited.

When presenting the operation method in the various examples described above, the presentation control unit 13 can determine whether or not it is necessary to present the operation method based further on the level of the host vehicle V driver's understanding on the driving assistance function. For example, when the level of understanding on the driving assistance function is high, it is considered that the driver knows or understands the operation method for the driving assistance function. For this reason, when the level of understanding on the driving assistance function is high, the presentation control unit 13 does not present the operation method even if it is determined in the various examples described above that the operation method for the driving assistance function should be presented.

Specifically, the information acquisition unit 11 acquires understanding level information of the driver of the host vehicle V regarding the driving assistance function. The presentation control unit 13 determines, based on the understanding level information acquired by the information acquisition unit 11, whether or not the level of understanding on the driving assistance function is equal to or higher than a predetermined understanding level threshold value. When the level of understanding on the driving assistance function is equal to or higher than the predetermined understanding level threshold value, the presentation control unit 13 does not present the operation method to the driver even if it is determined in the various examples described above that the operation method for the driving assistance function should be presented.

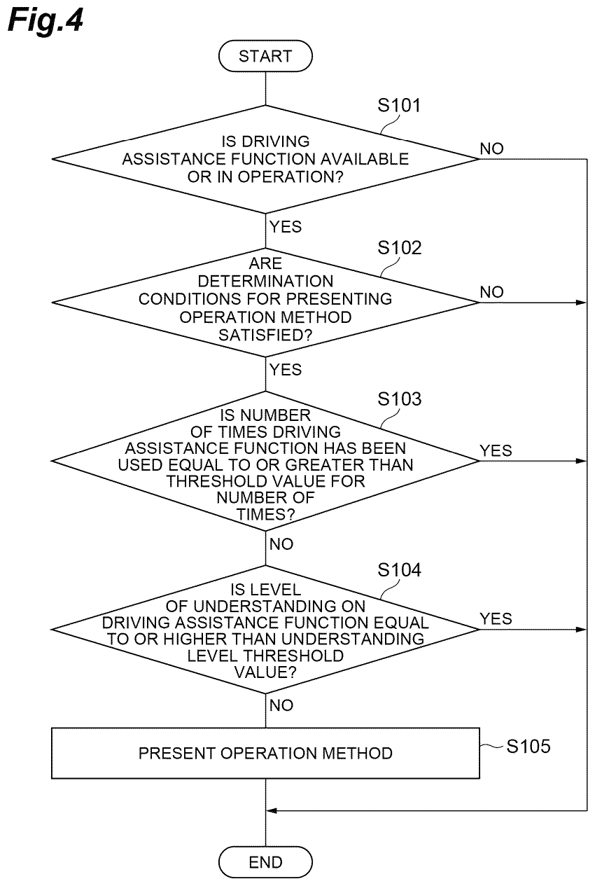

Next, the flow of an operation method presentation process performed by the assistance function presentation device 100 will be described. In addition, the process shown in FIG. 4 starts to be executed when the host vehicle V starts traveling. In addition, when the process reaches the end, the process starts from the start after a predetermined time. As shown in FIG. 4, the presentation control unit 13 determines whether or not the driving assistance function is available or in operation (S101). If the driving assistance function is not available or in operation (S101: NO), the process proceeds to END.

If the driving assistance function is available or in operation (S101: YES), the presentation control unit 13 determines whether or not determination conditions for presenting an operation method are satisfied (S102). The determination conditions include at least a condition that it is determined by the situation determination unit 12 that the current situation is not a high-load situation. When presenting the operation method described in the first specific example, the determination conditions in S102 further include a condition that the difference between the speed of the host vehicle V and the speed of each of other vehicles obtained from the surrounding environment information is equal to or greater than a predetermined speed threshold value. In addition, in this case, it is determined in S101 whether or not the vehicle speed maintenance function is in operation.

When presenting the operation method described in the second specific example, the determination conditions in S102 further include a condition that the difference between the speed of the host vehicle V and the speed limit indicated by the road sign obtained from the surrounding environment information is equal to or greater than a predetermined speed threshold value. In addition, in this case, it is determined in S101 whether or not the vehicle speed maintenance function is in operation. When presenting the operation method described in the third specific example, the determination conditions in S102 further include a condition that the host vehicle V is traveling on the highway and the calculated distance to the exit of the highway is equal to or less than a predetermined distance threshold value. In addition, in this case, it is determined in S101 whether or not the vehicle speed maintenance function is in operation.

Then, the presentation control unit 13 determines whether or not the number of times the driving assistance function has been used is equal to or greater than a threshold value for the number of times, based on the usage history information of the driving assistance function (S103). The driving assistance function that is a determination target herein is a driving assistance function determined in S101 to be available or in operation, and is a driving assistance function for which an operation method is to be presented. If the number of times the driving assistance function has been used is equal to or greater than the threshold value for the number of times (S103: YES), the process proceeds to END.

If the number of times the driving assistance function has been used is not equal to or greater than the threshold value for the number of times (S103: NO), the presentation control unit 13 determines whether or not the level of understanding on the driving assistance function is equal to or higher than an understanding level threshold value based on the understanding level information regarding the driving assistance function (S104). The driving assistance function that is a determination target herein is a driving assistance function determined in S101 to be available or in operation, and is a driving assistance function for which an operation method is to be presented. If the level of understanding on the driving assistance function is equal to or higher than the understanding level threshold value (S104: YES), the process proceeds to END. If the level of understanding on the driving assistance function is not equal to or higher than the understanding level threshold value (S104: NO), the presentation control unit 13 presents an operation method for the driving assistance function (S105). The driving assistance function for which an operation method is to be presented is a driving assistance function determined to be available or in operation in S101.

As described above, the assistance function presentation device 100 presents an operation method for the driving assistance function to the driver based not only on whether or not the driving assistance function is available or in operation but also on whether or not the driver is in a high-load situation in which a load on driving operations is high. Here, when the driver is in the high-load situation in which a load on driving operations is high, the driver needs to concentrate on the driving operations. In such a case, if an operation method for the driving assistance function is presented, the driver's attention to driving operations may be diverted. For this reason, the assistance function presentation device 100 presents an operation method to the driver when the driving assistance function is available or in operation and it is determined that the current situation is not a high-load situation. In this manner, the assistance function presentation device 100 can present an operation method for the driving assistance function at an appropriate timing. Then, the driver can easily operate the driving assistance function based on the presented operation method.

For example, it is assumed that the vehicle speed maintenance function is in operation as a driving assistance function. When the speed of the host vehicle V differs from the speed of other surrounding vehicles while the vehicle speed maintenance function is in operation, it is considered that the host vehicle V cannot travel along the flow of the other surrounding vehicles. That is, it may be preferable to change the set speed of the vehicle speed maintenance function so as to follow the flow of the other surrounding vehicles. For this reason, when it is determined by the situation determination unit 12 that the current situation is not a high-load situation and the difference between the speed of the host vehicle V and the speed of other surrounding vehicles is equal to or greater than a predetermined threshold value, the assistance function presentation device 100 presents a method for changing the set speed of the vehicle speed maintenance function. In this manner, the assistance function presentation device 100 can present a method for changing the set speed as an operation method for the vehicle speed maintenance function at a more appropriate timing. Then, the driver can easily perform an operation to change the set speed of the vehicle speed maintenance function based on the presented operation method.

For example, it is assumed that the vehicle speed maintenance function is in operation as a driving assistance function. When the speed of the host vehicle V differs from the speed limit indicated by the road sign while the vehicle speed maintenance function is in operation, it is considered that the host vehicle V cannot travel in accordance with the speed limit. That is, it may be preferable to change the set speed of the vehicle speed maintenance function so as to conform to the speed limit. For this reason, when the difference between the speed of the host vehicle V and the speed limit indicated by the road sign is equal to or greater than a predetermined threshold value, the assistance function presentation device 100 presents a method for changing the set speed of the vehicle speed maintenance function. In this manner, the assistance function presentation device 100 can present a method for changing the set speed as an operation method for the vehicle speed maintenance function at a more appropriate timing. Then, the driver can easily perform an operation to change the set speed of the vehicle speed maintenance function based on the presented operation method.

For example, in places other than highways, it may not be suitable or possible to use the vehicle speed maintenance function for driving the host vehicle V at a set speed. For this reason, it is preferable for the driver to deactivate the vehicle speed maintenance function before exiting the highway. Therefore, when the distance to the exit of the highway is equal to or less than a predetermined distance threshold value while the vehicle speed maintenance function is in operation, the assistance function presentation device 100 presents a method for canceling the vehicle speed maintenance function. In this manner, the assistance function presentation device 100 can present a method for canceling the vehicle speed maintenance function as an operation method for the vehicle speed maintenance function at a more appropriate timing. Then, the driver can easily perform an operation to cancel the vehicle speed maintenance function based on the presented operation method.

When the driving assistance function is used frequently, it is considered that the driver knows or understands the operation method for the driving assistance function. On the other hand, when the driving assistance function is used infrequently, it is considered that the driver does not know or understand the operation method for the driving assistance function. For this reason, when the number of times the driving assistance function has been used by the driver is equal to or greater than a predetermined threshold value for the number of times, the assistance function presentation device 100 does not present the operation method. On the other hand, when the number of times the driving assistance function has been used by the driver is less than the predetermined threshold value for the number of times, the assistance function presentation device 100 presents the operation method. In this manner, the assistance function presentation device 100 can more appropriately present the operation method for the driving assistance function based on the number of times the driving assistance function has been used. In addition, the assistance function presentation device 100 does not present the operation method to a driver who knows or understands the operation method for the driving assistance function. Therefore, the assistance function presentation device 100 can prevent the driver from feeling uncomfortable due to the presentation of the operation method for the driving assistance function.

When the level of understanding on the driving assistance function is high, it is considered that the driver understands the operation method for the driving assistance function. On the other hand, when the level of understanding on the driving assistance function is low, it is considered that the driver does not understand the operation method for the driving assistance function. For this reason, when the level of the driver's understanding on the driving assistance function is equal to or higher than a predetermined understanding level threshold value, the assistance function presentation device 100 does not present the operation method. On the other hand, when the level of the driver's understanding on the driving assistance function is less than the predetermined understanding level threshold value, the assistance function presentation device 100 presents the operation method. In this manner, the assistance function presentation device 100 can more appropriately present the operation method for the driving assistance function based on the level of understanding on the driving assistance function. In addition, the assistance function presentation device 100 does not present the operation method to a driver who understands the operation method for the driving assistance function. Therefore, the assistance function presentation device 100 can prevent the driver from feeling uncomfortable due to the presentation of the operation method for the driving assistance function.

While the embodiment of the present disclosure has been described above, the present disclosure is not limited to the above embodiment. For example, the assistance function presentation device 100 may be configured not to make a determination based on the number of times the driving assistance function has been used by the driver when determining whether or not it is necessary to present an operation method. In addition, for example, the assistance function presentation device 100 may be configured not to make a determination based on the level of the driver's understanding on the driving assistance function when determining whether or not it is necessary to present an operation method. At least some of the embodiment and various modification examples described above may be arbitrarily combined.

What is claimed is:

1. An assistance function presentation device for presenting an operation method for a driving assistance function of a vehicle, comprising:
an information acquisition unit configured to acquire surrounding environment information of the vehicle;
a situation determination unit configured to determine whether or not a driver of the vehicle is in a high-load situation in which a load on driving operations is high; and
a presentation control unit configured to present the operation method to the driver when the driving assistance function is available or in operation and it is determined by the situation determination unit that a current situation is not the high-load situation.

2. The assistance function presentation device according to claim 1,
wherein the surrounding environment information includes information on other vehicles around the vehicle,
the driving assistance function is a vehicle speed maintenance function for driving the vehicle at a set speed set in advance, and
when the vehicle speed maintenance function is in operation, it is determined by the situation determination unit that the current situation is not the high-load situation, and a difference between a speed of the vehicle and a speed of each of the other vehicles obtained from the surrounding environment information is equal to or greater than a predetermined speed threshold value, the presentation control unit presents a method for changing the set speed of the vehicle speed maintenance function as the operation method.

3. The assistance function presentation device according to claim 1,
wherein the surrounding environment information includes a recognition result of a road sign indicating a speed limit of a road on which the vehicle is traveling,
the driving assistance function is a vehicle speed maintenance function for driving the vehicle at a set speed set in advance, and
when the vehicle speed maintenance function is in operation, it is determined by the situation determination unit that the current situation is not the high-load situation, and a difference between a speed of the vehicle and the speed limit indicated by the road sign obtained from the surrounding environment information is equal to or greater than a predetermined speed threshold value, the presentation control unit presents a method for changing the set speed of the vehicle speed maintenance function as the operation method.

4. The assistance function presentation device according to claim 1,
wherein the information acquisition unit further acquires information on a driving route along which the vehicle travels,
the driving assistance function is a vehicle speed maintenance function for driving the vehicle at a set speed set in advance, and
when the vehicle is traveling on a highway, the presentation control unit calculates a distance to an exit where the vehicle is to exit the highway based on the driving route information, and presents a method for canceling the vehicle speed maintenance function as the operation method when the vehicle speed maintenance function is in operation, it is determined by the situation determination unit that the current situation is not the high-load situation, the vehicle is traveling on a highway, and the calculated distance to the exit is equal to or less than a predetermined distance threshold value.

5. The assistance function presentation device according to claim 1,
wherein the information acquisition unit further acquires usage history information of the driver of the vehicle regarding the driving assistance function, and
the presentation control unit determines, based on the usage history information, whether or not the number of times the driving assistance function has been used by the driver is equal to or greater than a predetermined threshold value for the number of times, and does not present the operation method to the driver when the number of times the driving assistance function has been used is equal to or greater than the predetermined threshold value for the number of times.

6. The assistance function presentation device according to claim 1,
wherein the information acquisition unit further acquires information on a level of the vehicle driver's understanding on the driving assistance function, and
the presentation control unit determines, based on the understanding level information, whether or not the level of understanding on the driving assistance function is equal to or greater than a predetermined understanding level threshold value, and does not present the operation method to the driver when the level of understanding is equal to or greater than the predetermined understanding level threshold value.
